(19) United States
(12) Patent Application Publication
(10) Pub. No.: US 2012/0168384 A1
(43) Pub. Date: Jul. 5, 2012

(54) DRUG-ADSORBING MATERIAL AND MEDICAL DEVICE COMPRISING SAME

(75) Inventors: Takao ANZAI, Ashigarakami-gun (JP); Takako Ariga, Ashigarakami-gun (JP)

(73) Assignee: TERUMO KABUSHIKI KAISHA, Shibuya-ku (JP)

(21) Appl. No.: 13/418,932

(22) Filed: Mar. 13, 2012

Related U.S. Application Data
(63) Continuation of application No. PCT/JP2010/066424, filed on Sep. 22, 2010.

(30) Foreign Application Priority Data
Sep. 30, 2009 (JP) 2009-227834

(51) Int. Cl. B01D 15/08; C08F 220/56

(52) U.S. Cl. 210/692; 525/296; 428/402; 210/263; 210/660

(57) ABSTRACT

A drug-adsorbing material capable of efficiently adsorbing and eliminating drugs (such as carcinostatic agents) from blood with a small amount without causing foreign body recognition reaction, such as blood coagulation, and a medical device provided with said drug-adsorbing material. The drug-adsorbing material is based on polymeric microparticles which swell upon adsorption of plasma components at pH value of 7 or above and keep their shape after swelling. The drug-adsorbing material is incorporated into a drug-administrating device for drug adsorption.

This application is a continuation of International Application No. PCT/JP2010/066424 filed on Sep. 22, 2010, and claims priority to Japanese Application No. 2009-227834 filed on Sep. 30, 2009, the entire content of both of which is incorporated herein by reference.

### TECHNICAL FIELD

Disclosed is a drug-adsorbing material for adsorbing, reducing and/or eliminating carcinostatic agents or the like, and also to a medical device provided therewith.

### BACKGROUND DISCUSSION

One of the current therapeutic practices for non-resectable malignant tumors is chemotherapy by systemic administration of carcinostatic agents. The chemotherapy in this manner can cause such side effects as cardiotoxicity, hepatotoxicity, and nephrotoxicity, and bone marrow suppression, and hence it is subject to strict limitations in the concentration, dosage, and dosing intervals of carcinostatic agents. Such limitations can lead to low concentrations of carcinostatic agents in tumor tissues, which is a hindrance to satisfactory therapeutic effects.

An attempt has been made to mitigate side effects due to systemic administration of carcinostatic agents, that is, intraarterial injection of carcinostatic agents in conjunction with means for adsorption of carcinostatic agents. This therapy includes injecting a carcinostatic agent through a catheter inserted into an artery near the tumor-bearing organ (such as the hepatic artery for the liver suffering from cancer), extracting blood from the hepatic vein, eliminating the carcinostatic agent from the extracted blood, and returning the processed blood to the vein. This therapeutic practice permits administration of carcinostatic agents at high concentrations only for the tumor-bearing region, and hence it is effective for advanced cancers. Activated carbon can be used as an adsorbing material to eliminate carcinostatic agents from blood. Activated carbon is a porous material with a very large specific surface area (500 to 1500 m²/g) and it has active sites (such as carboxyl groups and hydroxyl groups) on its surface, so that it adsorbs a variety of substances. Japanese Patent Laid-open No. Hei 7-67954 discloses a drug administrating device which uses activated carbon. This device includes a column filled with activated carbon and causes blood to pass through it for adsorption and elimination of carcinostatic agents from the blood.

The medical device disclosed in Japanese Patent Laid-open No. Hei 7-67954 can have the disadvantage that the activated carbon needs surface coating because, upon contact with blood, it destroys erythrocytes or stimulates leukocytes to release each kind of mediators, thereby enhancing the coagulation system to bring about blood coagulation. This surface coating can inevitably deteriorate adsorptivity, which can make it necessary to increase the amount of activated carbon or the amount of blood to be introduced into the adsorber.

### SUMMARY

Provided is an exemplary drug-adsorbing material which, even when used in a small amount, can adsorb and eliminate drugs, such as carcinostatic agents, without causing foreign body recognition reaction, such as blood coagulation.

Exemplary aspects can be achieved by polymeric microparticles that swell upon adsorption of plasma components at a pH value of 7 or above and keep their shape after swelling.

Provided is an exemplary drug-adsorbing material which includes polymeric microparticles capable of swelling upon adsorption of plasma components at a pH value of 7 or above, wherein the polymeric microparticles keep their shape after swelling.

The exemplary drug-adsorbing material swells upon adsorption of plasma components in blood, thereby producing the same environment as the blood components on its surface. It can selectively adsorb drugs without causing foreign body recognition reactions, such as adsorption and activation of platelets, leukocytes, and erythrocytes, for example, because it is free of surface coating detrimental to adsorptivity.

The exemplary drug-adsorbing material is capable of retaining its shape and hence does not need any material that functions as the core or nucleus. It can be formed from gel alone, and this saves the amount of the adsorbing material.

Provided is a method of adsorbing a drug, the method comprising contacting an exemplary drug-adsorbing material with blood.

Provided is a method of adsorbing a drug, the method comprising introducing blood to the blood inlet of an exemplary medical device.

### BRIEF DESCRIPTION OF DRAWINGS

FIG. 1 is a schematic diagram showing the circuit of the drug administrating apparatus provided with drug eliminating means containing the drug-adsorbing material, according to an exemplary aspect.

FIG. 2 is a sectional front view showing the structure of the drug eliminating means incorporated into the drug administrating apparatus shown in FIG. 1, according to an exemplary aspect.

### DETAILED DESCRIPTION

The drug-adsorbing material is composed of polymeric microparticles capable of swelling upon adsorption of plasma components at a pH value of 7 or above and keeping their shape after swelling.

A comparative activated carbon used as an adsorbing material for carcinostatic agents needs surface coating because, upon contact with blood, it destroys erythrocytes or stimulates leukocytes to release mediators, thereby enhancing the coagulation system to bring about blood coagulation. This surface coating inevitably deteriorates adsorptivity, which makes it necessary to increase the used amount of adsorbing material or the amount of blood to be introduced into the adsorber.

Unlike the comparative activated carbon, an exemplary drug-adsorbing material described herein is composed of polymeric microparticles that swell upon adsorption of plasma components at a pH value of 7 or above and keep their shape after swelling (hereinafter simply referred to as “polymeric microparticles”). The polymeric microparticles adsorb plasma components (such as water, proteins, and ions) at a pH value of 7 or above, for example, under weak alkaline conditions, such as blood which has a pH value of 7.3 to 7.6. Upon adsorption of plasma components, they change into swollen gel. The swollen gel contains a large amount of plasma components and hence resembles blood. Thus it is recognized as plasma components by blood cells (such as platelets, leukocytes, and erythrocytes) and plasma protein and is not recognized as a foreign body. For this reason, for example, it can reduce or avoid bringing about blood coagulation and inflammation, and it can reduce or avoid side effects such as decrease of platelets and leukocytes in the perfused blood. Unlike activated carbon, exemplary polymeric microparticles do not destroy erythrocytes, stimulate leukocytes to release mediators, and cause blood coagulation by enhancement of coagulation system. On account of these properties, exemplary polymeric microparticles do not need surface coating and are free of surface coating. This means that they can exhibit their excellent adsorbing performance without their adsorbing performance being aggravated by surface coating.

The drug-adsorbing material is composed of the polymeric microparticles which keep their shape after swelling, and hence it retains its gel form. The resulting gel alone functions as the adsorbing material without requiring cores or nuclei. The absence of cores or nuclei helps reduce the used amount of the adsorbing material.

Exemplary polymeric microparticles swell upon adsorption of plasma components at a pH value of 7 or above and keep their shape after swelling. For example, they swell upon adsorption of plasma component under the weak alkaline conditions of body fluid (such as blood or spinal fluid) which has a pH value of 7.3 to 7.6.

The polymeric microparticles are not specifically restricted in structure. They can be microparticles of pH-responsive swelling crosslinked polymer (A) formed from a copolymer and a crosslinking agent (a3), said copolymer being composed of structural units derived from (meth)acrylamide monomer (a1) and structural units derived from unsaturated carboxylic acid monomer (a2). The copolymer composed of structural units derived from a monomer having amide groups and structural units derived from a monomer having carboxyl groups is highly hydrophilic and antithrombotic. For example, it is also scarcely recognizable or not recognizable as a foreign body and hence it hardly becomes a source of infection. In an exemplary instance, the polymeric microparticles are pH-responsive swelling crosslinked polymer (A) formed from a copolymer and a crosslinking agent (a3), the copolymer being composed of structural units derived from (meth)acrylamide monomer (a1) and structural units derived from unsaturated carboxylic acid monomer (a2).

An exemplary embodiment is described below, with a description of the pH-responsive swelling crosslinked polymer (A). However, it is not intended to restrict the scope of the disclosure.

Monomers Constituting the pH-Responsive Swelling Crosslinked Polymer (A)

(meth)acrylamide Monomer (a1)

The (meth)acrylamide monomer (a1) as one constituent of the pH-responsive swelling crosslinked polymer (A) is not specifically restricted. The (meth)acrylamide monomer (a1) permits the pH-responsive swelling crosslinked polymer (A) to keep its shape.

It includes, for example, (meth)acrylamide, N-methyl(meth)acrylamide, N-ethyl(meth)acrylamide, N-n-propyl(meth)acrylamide, N-isopropyl(meth)acrylamide, N-n-butyl(meth)acrylamide, N-isobutyl(meth)acrylamide, N-s-butyl(meth)acrylamide, N-t-butyl(meth)acrylamide, N,N-dimethyl(meth)acrylamide, N-ethyl-N-methyl(meth)acrylamide, N,N-diethyl(meth)acrylamide, N-methyl-N-n-propyl(meth)acrylamide, N-methyl-N-isopropyl(meth)acrylamide, N-ethyl-N-n-(meth)acrylamide, N-ethyl-N-isopropyl(meth)acrylamidepropyl, N,N-di-n-propyl(meth)acrylamide, diacetone(meth)acrylamide, crotonylamide, and cinnamylamide. They may be used alone or in combination of two or more. Exemplary among them is (meth)acrylamide which is highly safe for the living body in the field of orthopedic surgery. The term “(meth)acrylamide” used herein embraces both acrylamide and methacrylamide.

The copolymer is not specifically restricted in the amount of its constituent units derived from (meth)acrylamide monomer (a1), so long as it turns into the pH-responsive swelling crosslinked polymer (A) as desired. The (meth)acrylamide monomer (a1) can account for, for example, 40 to 90 mass %, for example, 50 to 85 mass %, in the total amount of the monomers constituting the copolymer.

Unsaturated Carboxylic Acid Monomer (a2)

The unsaturated carboxylic acid monomer (a2) as monomer constituent of the pH-responsive swelling crosslinked polymer (A) is not specifically restricted. The unsaturated carboxylic acid monomer (a2) permits the pH-responsive swelling crosslinked polymer (A) to adsorb drugs.

It includes, for example, (meth)acrylic acid, maleic acid, fumaric acid, glutaconic acid, itaconic acid, crotonic acid, sorbic acid, and cinnamic acid. They may be in the form of salt, such as sodium salt, potassium salt, and ammonium. In the case where the unsaturated carboxylic acid monomer in the form of salt is used for copolymerization, the resulting (co)polymer may undergo acid treatment as mentioned later, so that carboxylate salt as one constituent of the unsaturated carboxylic acid monomer (a2) is converted into the carboxyl group. The unsaturated carboxylic acid monomers (a2) or salts thereof listed above may be used alone or in combination of two or more.

Of the above-mentioned examples, (meth)acrylic acid or sodium (meth)acrylate is exemplary because the resulting copolymer swells at a pH value of 7 or above or in the neutral to alkaline regions. The term “(meth)acrylic acid” used herein embraces both acrylic acid and methacrylic acid.

The copolymer is not specifically restricted in the amount of its constituent units derived from the unsaturated carboxylic acid monomer (a2) or the salt thereof, so long as it turns into the pH-responsive swelling crosslinked polymer as desired. The unsaturated carboxylic acid monomer (a2) can account for, for example, 60 to 10 mass %, for example, 50 to 15 mass %, in the total amount of the monomers constituting the copolymer.

It is possible to employ either block or random copolymerization to form the copolymer from the constituent units derived from the (meth)acrylamide monomer (a1) and the constituent units derived from the unsaturated carboxylic acid monomer (a2) mentioned above. Crosslinking agent (a3)

The crosslinking agent (a3) for preparation of the pH-responsive swelling crosslinked polymer (A) is not specifically restricted. It may be selected from the following three crosslinking agents:
(i) a crosslinking agent having at least two polymerizable unsaturated groups;
(ii) a crosslinking agent having at least one each of polymerizable unsaturated group and reactive functional group excluding polymerizable unsaturated group;
(iii) a crosslinking agent having at least two reactive functional groups excluding polymerizable unsaturated group.
   They may be used alone or in combination of two or more.

In the case where the crosslinking agent (i) is used alone, it can be added to the polymerization system when copolymerization is performed on the (meth)acrylamide monomer (a1) and the unsaturated carboxylic acid monomer (a2) (or the salt thereof). In the case where the crosslinking agent (iii) is used alone, it can be added after copolymerization has been performed on the (meth)acrylamide monomer (a1) and the unsaturated carboxylic acid monomer (a2), and the resulting copolymer can undergo post-crosslinking with heating. In the case where the crosslinking agent (ii) is used alone or any two or more of the crosslinking agents (i), (ii), and (iii) are used in combination, they can be added to the polymerization system when copolymerization is performed on the (meth)acrylamide monomer (a1) and the unsaturated carboxylic acid monomer (a2), and the resulting copolymer can undergo post-crosslinking with heating.

The crosslinking agent (i) having at least two polymerizable unsaturated groups is exemplified by the following: N,N′-methylenebisacrylamide, N,N′-methylenebismethacrylamide, N,N′-ethylenebisacrylamide, N,N′-ethylenebismethacrylamide, N,N′-hexamethylenebisacrylamide, N,N′-hexamethylenebismethacrylamide, N,N′-benzylidenebisacrylamide, N,N′-bis(acrylamidemethylene)urea, ethyleneglycol di(meth)acrylate, polyethyleneglycol di(meth)acrylate, propyleneglycol di(meth)acrylate, glycerin (di- or tri-)acrylate, trimethylolpropane triacrylate, triallylamine, triallylcyanurate, triallylisocyanurate, tetraallyloxyethane, pentaerythritol allyl ether, (poly)ethyleneglycol di(meth)acrylate, polypropyleneglycol di(meth)acrylate, trimethylolpropane tri(meth)acrylate, glycerin tri(meth)acrylate, glycerin acrylate-methacrylate, ethyleneoxide-modified trimethylolpropane tri(meth)acrylate, pentaerythritol hexa(meth)acrylate, triallyl cyanurate, triallyl isocyanurate, triallyl phosphate, triallylamine, poly(meth)allyloxyalkane, (poly)ethyleneglycol diglycidyl ether, glycerol diglycidyl ether, ethylene glycol, polyethylene glycol, propylene glycol, glycerin, pentaerythritol, ethylenediamine, ethylene carbonate, propylene carbonate, and glycidyl(meth)acrylate.

The crosslinking agent (ii) having at least one each of polymerizable unsaturated group and reactive functional group excluding polymerizable unsaturated group is exemplified by the following: Hydroxyethyl(meth)acrylate, N-methylol(meth)acrylamide, and glycidyl(meth)acrylate.

The crosslinking agent (iii) having at least two reactive functional groups excluding polymerizable unsaturated group is exemplified by the following: Polyhydric alcohol (such as ethylene glycol, diethylene glycol, glycerin, propylene glycol, and trimethylolpropane), alkanolamine (such as diethanolamine), and polyamine (such as polyethyleneimine).

Exemplary among the foregoing examples is the one (i) having at least two polymerizable unsaturated groups; exemplary is N,N′-methylenebisacrylamide.

The amount of the crosslinking agent (a3) can be 0.1 to 1 mass %, for example, 0.15 to 0.5 mass %, for the total amount (100 mass %) of the monomers or the sum of (a1) and (a2).

Method for Production of pH-Responsive Swelling Crosslinked Polymer

The pH-responsive swelling crosslinked polymer (A) mentioned above may be produced by any method without specific restrictions. An exemplary method includes copolymerizing the (meth)acrylamide monomer (a1) and the unsaturated carboxylic acid monomer (a2) (or the salt thereof), together with the crosslinking agent (a3) optional), followed by post-crosslinking (optional).

The copolymerization may be accomplished in any known way without specific restrictions, such as solution polymerization which employs a polymerization initiator, emulsion polymerization, suspension polymerization, reverse phase suspension polymerization, thin film polymerization, and spray polymerization. A desired rate of polymerization may be achieved by adiabatic polymerization, temperature-controlled polymerization, or isothermal polymerization. The polymerization may be initiated by exposure to radiation, electron rays, or UV light in addition to incorporation with a polymerization initiator. Exemplary methods for polymerization are solution polymerization which employs a polymerization initiator, suspension polymerization, and reverse phase suspension polymerization. The following is a detailed description of reverse phase suspension polymerization.

### Reverse Phase Suspension Polymerization

The reverse phase suspension polymerization employs the continuous phase which is one or more of solvents selected from aliphatic organic solvents, such as n-hexane, n-heptane, n-octane, n-decane, cyclohexane, methylcyclohexane, and fluid paraffin; aromatic organic solvents, such as toluene and xylene; and halogenated organic solvents, such as 1,2-dichloroethane. Exemplary among these solvents are aliphatic organic solvents, such as hexane, cyclohexane, and fluid paraffin. The foregoing solvents may be used alone or in combination of two or more.

The continuous phase may be incorporated with a dispersant. With its amount and kind properly selected, the dispersant permits the pH-responsive swelling polymer to have a particle size of the microparticles as desired.

Examples of the dispersant include such nonionic surface active agents as polyoxyethylene lauryl ether, polyoxyethylene oleyl ether, polyoxyethylene stearyl ether, sorbitan sesquioleate, sorbitan trioleate, sorbitan monolaurate, sorbitan monooleate, sorbitan monopalmitate, sorbitan monostearate, sorbitan tristearate, glycerol monostearate, glycerol monooleate, glyceryl stearate, glyceryl caprate, sorbitan stearate, sorbitan oleate, sorbitan sesquioleate, and coconut fatty acid sorbitan.

The amount of the foregoing dispersant to be used for the solvent as the continuous phase can range, for example, from 0.04 to 20 mass %, for example, from 1 to 12 mass %. An amount less than 0.04 mass % can be too small for the dispersant to prevent the polymer from coagulating. An amount more than 20 mass % can be too large for the dispersant to keep the resulting microparticles uniform in particle size distribution.

In the reverse phase suspension polymerization mentioned above, the monomer concentration is not specifically restricted. An exemplary range is 2 to 7 mass %, for example, 3 to 5 mass %, for the amount of the solvent as the continuous phase.

The reverse phase suspension polymerization mentioned above employs a polymerization initiator exemplified below. Persulfate such as potassium persulfate, ammonium persulfate, and sodium persulfate; peroxide such as methyl ethyl ketone peroxide, methyl isobutyl ketone peroxide, di-t-butyl peroxide, t-butylcumyl peroxide, t-butyl peroxyacetate, t-butyl peroxyisobutyrate, t-butyl peroxypivalate, hydrogen peroxide; and azo compound such as 2,2′-azobis[2-(N-phenylamidino)propane]dihydrochloride, 2,2′-azobis[2-(N-allylamidino)propane]dihydrochloride, 2,2′-azobis{2-[1-(2-hydroxyethyl)-2-imidazolin-2-yl]propane}dihydrochloride, 2,2′-azobis{2-methyl-N-[1,1-bis(hydroxymethyl)-2-hydroxyethyl]propionamide}, 2,2′-azobis[2-methyl-N-(2-hydroxyethyl)-propionamide], and 4,4′-azobis(4-cyanovaleric acid). They may be used alone or in combination of two or more. Exemplary among them are persulfates, particularly potassium persulfate, ammonium persulfate, and sodium persulfate, which are readily available and good in handling properties.

Incidentally, the polymerization initiator mentioned above may be used in combination with a reducing agent such as sodium sulfite, sodium hydrogen sulfite, ferrous sulfate, L-ascorbic acid, and N,N,N′N′-tetramethylethylenediamine. Such a combination works as a redox polymerization initiator.

The amount of the polymerization initiator to be used for the reverse phase suspension polymerization can be 2 to 6 mass %, for example, 3 to 5 mass %, for the total amount (100 mass %) of the monomers involved. An amount less than 2 mass % is too small for the polymerization initiator to advance the polymerization reaction itself. With an amount more than 6 mass %, the polymerization initiator may give rise to a polymer which has an excessively small molecular weight and which coagulates due to an excessively high viscosity.

The system for copolymerization may optionally be incorporated with a chain transfer agent as exemplified below: thiols (such as n-laurylmercaptan, mercaptoethanol, and triethyleneglycol dimercaptan), thiol acids (such as thioglycolic acid and thiomalic acid), secondary alcohols (such as isopropanol), amines (such as dibutylamine), and hypophosphites (such as sodium hypophosphite).

The reverse phase suspension polymerization may be carried out under any polymerizing conditions without specific restrictions. For example, the polymerization temperature may be established properly according to the type of the catalyst to be used; it can be 35 to 75° C., for example, 40 to 50° C. A polymerization temperature lower than 35° C. can be too low for polymerization reaction itself to proceed. At a polymerization temperature higher than 70° C., the dispersing medium can evaporate, thereby aggravating the dispersion of the monomers. The duration of polymerization can be equal to or longer than one hour, for example, two to six hours.

Polymerization may be carried out in the system at any pressure (atmospheric, reduced, or pressurized) without specific restrictions. In addition, reaction may take place in the system in any atmosphere (air or inert gas such as nitrogen and argon) without specific restriction. The following is a detailed description of the solution polymerization. Solution polymerization

The solution polymerization is carried out in a solvent which is selected according to its ability to dissolve the monomers (a1) and (a2) and the crosslinking agent. An exemplary solvent is water, and ethyl alcohol is also suitable.

The solution polymerization can vary in monomer component concentration without specific restrictions. It can be from 5 to 30 mass %, for example, from 10 to 25 mass %.

The solution polymerization mentioned above employs a polymerization initiator without specific restrictions which is the same one as used for the reverse phase polymerization. They may be used alone or in combination of two or more. Exemplary ones are persulfates, for example, potassium persulfate, ammonium persulfate, and sodium persulfate, which are readily available and good in handling properties.

The polymerization initiator mentioned above may be used in combination with a reducing agent such as sodium sulfite, sodium hydrogen sulfite, ferrous sulfate, L-ascorbic acid, and N,N,N′N′-tetramethylethylenediamine. Such a combination works as a redox polymerization initiator.

The used amount of the polymerization initiator can be 0.1 to 1.5 parts by mass, for example, 0.15 to 1.0 part by mass, for the total amount (100 parts by mass) of the monomers involved. This amount is adequate for the polymerization of desired monomers to give a polymer having a desirable molecular weight and free of coagulation.

The system for solution polymerization may optionally be incorporated with a chain transfer agent while copolymerization, which is the same one as used for the reverse phase polymerization.

The solution polymerization may be carried out under any polymerizing conditions without specific restrictions. For example, the polymerization temperature may be established properly according to the type of the catalyst to be used. It can be 15 to 50° C., for example, 20 to 40° C. This temperature permits the polymerization reaction to proceed completely while reducing or preventing dispersing medium evaporation and ensuring good monomer component dispersion. The duration of polymerization can be equal to or longer than one hour, for example, two to six hours.

Polymerization may be carried out in the system at any pressure (atmospheric, reduced, or pressurized) without specific restrictions. In addition, reaction may take place in the system in any atmosphere (air or inert gas such as nitrogen and argon) without specific restriction.

The reverse phase suspension polymerization and the solution polymerization are described above. In the case where the crosslinking agent (a3) used in the reverse phase suspension polymerization and the solution polymerization mentioned above is the crosslinking agent (iii) having at least two reactive functional groups excluding the polymerizable unsaturated group, the additional agent (iii) may be added for post-crosslinking after the completion of the polymerization reaction of the monomers.

The post-crosslinking may be carried out at a specific temperature that depends on the type of the crosslinking agent (a3) involved. The temperature for post-crosslinking can be 50 to 150° C., and the duration of post-crosslinking can be one to 48 hours.

The copolymerization may be carried out in the presence of a pore-forming material supersaturatedly suspended in the monomer solution, so that the resulting polymer becomes porous. The pore-forming material can be one which is insoluble in the monomer solution but soluble in the washing solution. Examples of the pore-forming material include sodium chloride, potassium chloride, ice, sucrose, and sodium hydrogen carbonate, with the first one being exemplary. The concentration of the pore-forming material in the monomer solution can range from 5 to 50 mass %, for example, from 10 to 30 mass %.

In the case where the unsaturated carboxylic acid monomer (a2) in the form of salt is used copolymerization, the resulting copolymer can undergo acid treatment, so that the carboxylate salt of the polymeric microparticles is converted into the carboxyl group. As the result of this acid treatment, it is possible to obtain the pH-responsive polymeric microparticles which swell or shrink in response to the pH value. The acid treatment may be carried out under any condition without specific restrictions, such as the one with a low pH aqueous solution of hydrochloric acid at 15 to 60° C., for example, for one to 72 hours.

If the acid treatment is carried out, it can be followed by heat drying at 40 to 80° C., for example, 40 to 60° C. This temperature is adequate for the microparticles to dry completely without cracking or chapping.

The heat drying may be accomplished by using an ordinary apparatus such as oven and hot-air drier. More than one drier may be used in combination.

The pH-responsive swelling crosslinked polymer (A) which is obtained as mentioned above may be heat-dried and crushed according to need. In this way there are obtained the pH-responsive swelling polymeric microparticles.

The pH-responsive swelling crosslinked polymeric microparticles may take on any shape, such as sphere, string, crushed, and amorphous, without specific restrictions. A stringy shape is exemplary.

The polymeric microparticles are not specifically restricted in size. An adequate size can be selected according to the desired use and the size of the drug supply apparatus. The polymeric microparticles in their dry state can have an average particle diameter of 10 to 150 μm, for example, 20 to 100 μm, for example, 30 to 60 μm. With a particle size smaller than the lower limit, they can be hardly filled into the module of the medical device. With an average particle size larger than the upper limit, they can be slow in swelling. The exemplary particle size specified above is desirable for the polymeric microparticles to be produced easily, to adsorb drugs efficiently, and to keep their shape after swelling. In the case where the particle size specified above is not obtained, the polymeric microparticles may undergo classification (to remove undersized particles) or crushing (to remove oversized particles).

The pH-responsive swelling polymeric microparticles will have the shape and average particle diameter as specified above only when they are produced under adequately controlled conditions, including the type of monomers, the temperature and duration of copolymerization, and the amount and kind of dispersant. The average particle diameter can be measured by using a Coulter counter in the dry state. The average particle diameter of the polymeric microparticles is that measured in the dry state, unless otherwise stated.

The pH-responsive swelling polymeric microparticles mentioned above will swell upon adsorption of water at a pH value of, for example, 7 or above, for example, under a weak alkaline condition such as blood which has a pH value of 7.3 to 7.6.

### Drugs for Adsorption

The pH-responsive swelling polymeric microparticles mentioned above adsorb any drug without specific restrictions. They efficiently adsorb those drugs which have positive charges because their constituent units derived from the unsaturated carboxylic acid monomer (a2) (or a salt thereof) carry negative charges.

Examples of the drugs to be adsorbed are listed below: gemcitabine hydrochloride, doxorubicin hydrochloride, melphalan, cisplatin, mitomycin, irinotecan hydrochloride, metabolic antagonist, folate metabolism antagonist, pyrimidine metabolism inhibiitor, purine metabolism inhibitor, ribonucleotide reductase inhibitor, nucleotide analog, alkylating agent, topoisomerase inhibitor, microtubule polymerization inhibitor, microtubule depolymerization inhibitor, carcinostatic agents such as molecular target drug, and contrast medium such as water-soluble iodine contrast medium, gadolinium contrast medium, and fluorescent contrast medium. Exemplary are gemcitabine hydrochloride, doxorubicin hydrochloride, melphalan, cisplatin, mitomycin, and irinotecan hydrochloride, which have the structure of amine or amine hydrochloride.

### Medical Device

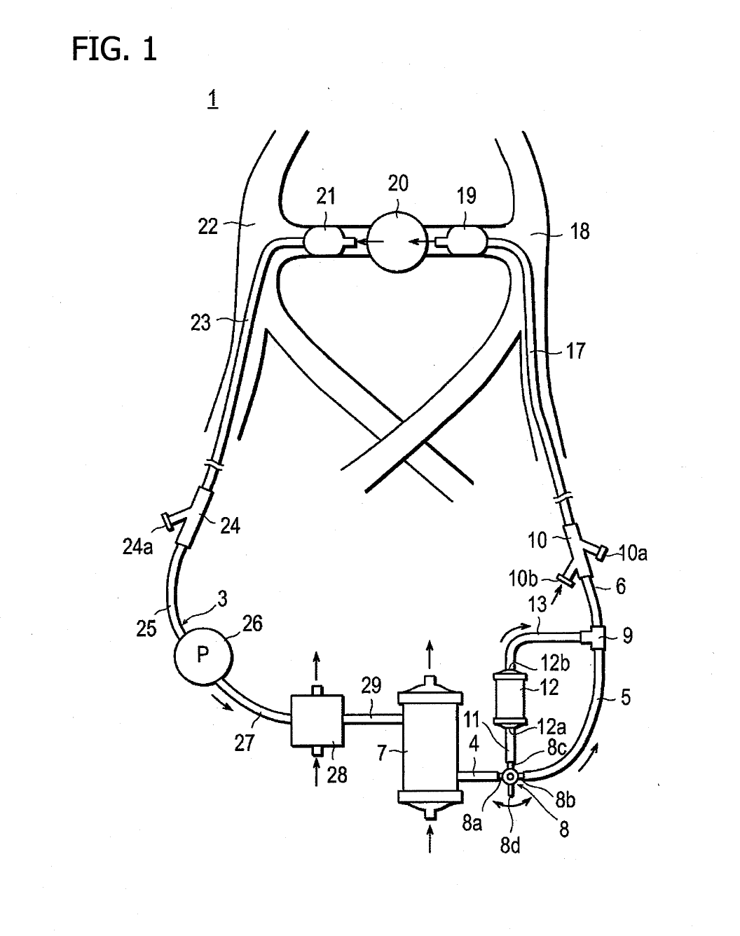

The drug adsorbing material mentioned above is not specifically restricted in its application. It can be used as a substitute for the adsorbing material disclosed in Japanese Patent Laid-open No. Hei 7-67954. It can be used as the drug adsorbing material 2 of the drug administrating device 1 shown in FIG. 1. FIG. 1 is a schematic diagram showing the circuit of the drug administrating device 1 provided with the drug adsorbing material 2. The drug administrating device 1 shown in FIG. 1 includes drug eliminating means such as a drug eliminating device, designed to eliminate the ingredient of the carcinostatic agent from the blood flowing through a circulating circuit 3. The drug administrating device 1 is constructed as described in the following.

The drug administrating device 1 is provided with three tubes 4, 5, and 6. One end of the tube 4 is connected to the blood outlet (not shown) of an artificial lung 7. The other end of the tube 4 and one end of the tube 5 are connected respectively to a first port 8a and a second port 8b of a three-way stop cock 8 to switch the flow channel. The other end of the tube 5 and one end of the tube 6 are connected to each other through a T-shaped branching connecter 9. The other end of a tube 6 is connected to the base end of a hub 10.

One end of a tube 11 is connected to a third port 8c of the three-way stop cock 8, and the other end of the tube 11 is connected to a blood inlet 12a of the drug eliminating means 12 mentioned later. One end of a tube 13 is connected to a blood outlet 12b of the drug eliminating means 12, and the other end of the tube 13 is connected to the branch end of the branching connector 9.

The tubes 11 and 13 and the drug eliminating means 12 constitute a bypass to detour the tube 5 which is a portion of the circulating circuit 3.

The three-way stop cock 8 has a lever 8d which upon rotation directs the fluid flow from the first port 8a to the second port 8b or from the first port 8a to the third port 8c. In the first case, the blood flows from the tube 4 to the tube 5, and in the second case, the blood flows from the tube 4 to the tube 13 or flows through the bypass.

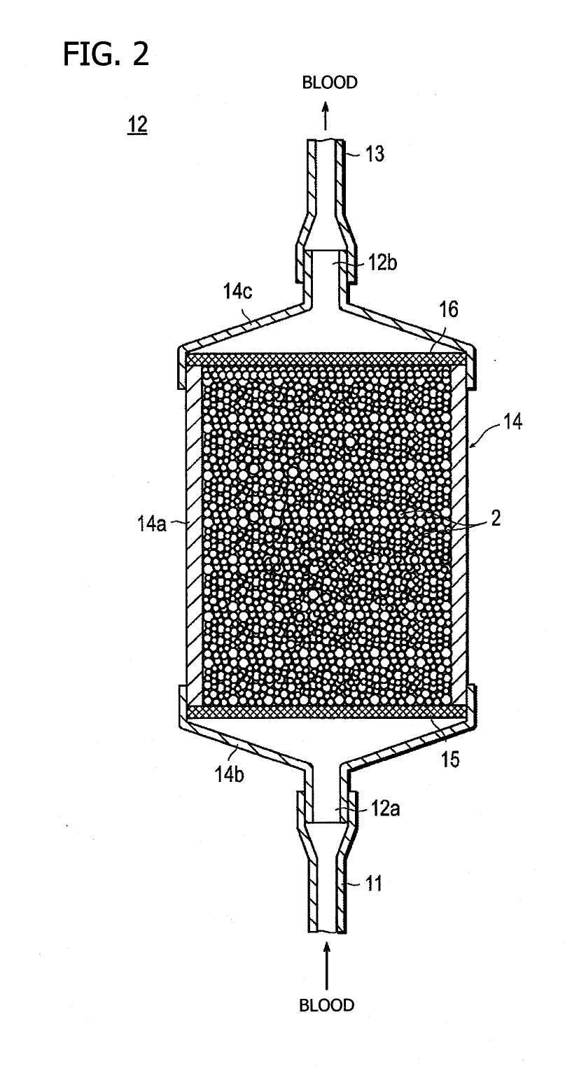

FIG. 2 is a sectional front view showing the structure of the drug eliminating means 12 incorporated in the drug administrating device 1. It is noted from FIG. 2 that the drug eliminating means 12 includes a column 14 composed of a cylindrical column body 14a and funnel-shaped lids 14b and 14c attached to both ends thereof. The lids 14b and 14c have the blood inlet 12a and outlet 12b formed at their respective tops. The blood inlet 12a and outlet 12b are connected respectively to the ends of the tube 11 and the tube 13.

The cylindrical column body 14a has its both open ends closed by the supporting members (or filters) 15 and 16 which fix the granular adsorbing material 2 therein. The supporting members 15 and 16 are a mesh which has a large number of fine pores so that it passes the blood but blocks the adsorbing material 2. The column body 14a and the supporting members 15 and 16 define the space which is filled with the drug adsorbing material 2.

The drug eliminating means 12 works as follows. The blood containing carcinostatic agents, which is supplied through the tube 11, passes through the blood inlet 12a, enters the space surrounded by the lid 14b and the supporting member 15, passes through the supporting member 15, enters the column body 14a, and comes into contact with the adsorbing material 2 which adsorbs and eliminates the carcinostatic agents. The treated blood passes through the supporting member 16, flows into the space surrounded by the lid 14c and the supporting member 16, and flows out from the column 14 through the blood outlet 12b.

### EXAMPLES

Exemplary aspects will be described in more detail to show exemplary effects with reference to the following Examples and Comparative Examples, which are not intended to restrict the scope of the disclosure.

### Example 1

A brown vial was filled with 2.5 g of acrylamide (product of Wako Pure Chemical Industries, Ltd.), 0.5 g of sodium acrylate (synthetic product), 0.006 g of N,N′-methylenebisacrylamide (product of Wako Pure Chemical Industries, Ltd.), and 20.0 g of distilled water, followed by dissolution by stirring with a magnetic stirrer. The brown vial was further given 5.4 g of sodium chloride (product of Naigai), followed by stirring with a magnetic stirrer. Thus there was obtained a monomer solution. The vial was evacuated by a vacuum pump and then left in a vacuum desiccator for more than five minutes. A polymerization initiator containing 20 mass % of ammonium persulfate was prepared from 0.2 g of ammonium persulfate (product of Wako Pure Chemical Industries, Ltd.) and 0.8 g of distilled water by dissolution in a test tube. The monomer aqueous solution was given 0.127 mL of tetramethylethylenediamine (product of Tokyo Chemical Industry Co., Ltd.) and 100 μL of the polymerization initiator, with stirring by a magnetic stirrer. The contents of the vial were filled into a polyethylene tube having an inside diameter of 0.5 mm, in which polymerization took place for two hours. The resulting polymer was vacuum-dried in an oven at 55° C. The dried polymer was allowed to stand in distilled water, so that it swelled with water for conversion into hydrogel, and the monomer remaining unreacted and the sodium chloride were removed. The thus obtained hydrogel was placed in ethanol for dehydration and drying. The resulting dried product was placed in 2.5-N hydrochloric acid which was heated for 46 hours in an oven at 55° C. This step was followed by washing with distilled water which was repeated several times until the washings showed no change in pH. The washed product was vacuum-dried in an oven at 55° C. After cutting or crushing, there were obtained polymeric microparticles having an average particle diameter of 100 μm.

### Example 2

The same procedure as in Example 1 was repeated except that the amount of acrylamide was changed to 2.0 g and the amount of sodium acrylate was changed to 1.0 g. Thus, there was obtained a sample of polymeric microparticles having an average particle diameter of 100 μm as in Example 1.

### Example 3

The same procedure as in Example 1 was repeated except that the amount of acrylamide was changed to 1.5 g and the amount of sodium acrylate was changed to 1.5 g. Thus, there was obtained a sample of polymeric microparticles having an average particle diameter of 100 μm as in Example 1.

### Example 4

Preparation of pH-Responsive Swelling Polymeric Microparticles (having an Average Particle Diameter of 30 μm) by Reverse Phase Suspension Polymerization

In a 300-mL beaker were placed 150 g of cyclohexane, 150 g of fluid paraffin, and 15.9 g of sorbitan sesquioleate. The contents of the beaker were stirred by a magnetic stirrer, so that the continuous phase of reverse phase suspension polymerization was prepared. The resulting continuous phase underwent nitrogen bubbling for 30 minutes to remove dissolved oxygen. Meanwhile, a 50-mL brown glass vial was filled with 3.8 g of acrylamide, 2.2 g of sodium acrylate, 0.013 g of N,N′-methylenebisacrylamide, 5.4 g of sodium chloride, and 19.9 g of distilled water. After dissolution by stirring with a magnetic stirrer, there was obtained an aqueous solution of monomer. The aqueous solution of monomer was given a solution of 0.27 g of ammonium persulfate dissolved in 2.0 g of distilled water. All of the aqueous solution of monomer was added to the previously prepared continuous phase. The resulting mixture was stirred at 300 rpm for dispersion of the monomer solution into the continuous phase. After stirring for 30 minutes and heating to 40° C., the suspension was given 100 μL of N,N,N′,N′-tetramethylethylenediamine. Additional stirring was continued for an hour, and the contents of the beaker were transferred to a 3-L beaker. One liter of n hexane was added, which was followed by stirring for five minutes and decantation to remove the supernatant fluid. The resulting precipitates were washed twice with 500 mL of n hexane. One liter of distilled water was added to the washed precipitates for dissolution. Two liters of ethanol was added for polymer separation. Precipitates of polymer were recovered by decantation, and the recovered polymer was crushed by stirring in ethanol. With 2.5-N hydrochloric acid added, the crushed polymer was allowed to stand for 24 hours in an oven at 55° C. After acid treatment, the crushed polymer was placed in distilled water, and the distilled water was replaced repeatedly until no pH change occurred in it any longer. After washing, ethanol was added to the crushed polymer. Finally, the crushed polymer underwent dehydration, and classification through a stainless steel sieve. Thus there was obtained a sample of polymeric microparticles having an average particle diameter of 30 μm.

### Comparative Example 1

The same procedure as Example 1 was repeated except that the amount of acrylamide was changed to 3.0 g and sodium acrylate was not used. Thus there was obtained a sample of polymeric microparticles having an average particle diameter of 100 μm.

### Comparative Example 2

The same procedure as Example 1 was repeated except that the amount of acrylamide was changed to 1.0 g and the amount of sodium acrylate was changed to 2.0 g. Thus there was obtained a sample of polymeric microparticles having an average particle diameter of 100 μm.

### Comparative Example 3

The same procedure as Example 1 was repeated except that the amount of acrylamide was changed to 0.5 g and the amount of sodium acrylate was changed to 2.5 g. Thus there was obtained a sample of polymeric microparticles having an average particle diameter of 100 μm.

### Comparative Example 4

The same procedure as Example 1 was repeated except that acrylamide was not used and the amount of sodium acrylate was changed to 3.0 g. Thus there was obtained a sample of polymeric microparticles having an average particle diameter of 100 μm.

### Test Example 1

### Test on Gel for Ability to Keep Shape After Swelling

The intermediate product (gel) obtained after polymerization, drying, and swelling with water in production of polymeric microparticles in Examples 1 to 3 and Comparative Examples 1 to 4 was placed in a petri dish (9 cm in diameter) and examined to see how it changes in shape as water surrounding it is removed. It was found that the samples of Examples 1 to 3 and Comparative Example 1 kept the stringy shape (which is observed after polymerization and drying) but the samples of Comparative Examples 2 to 4 broke.

### Test Example 2

Test for pH-Responsiveness After Swelling

Each sample of the polymeric microparticles (final product after treatment with hydrochloric acid) in Examples 1 to 3 and Comparative Examples 1 to 4 was added to distilled water and physiological saline (PBS), which is adjusted to pH 7.4 with phosphoric acid buffer solution, to see if it swells with water in response to pH. The samples in Examples 1 to 3 swelled only in PBS, and accordingly they swelled in response to pH. On the other hand, the sample in Comparative Example 1 swelled in both water and PBS. Accordingly, it had no pH-responsiveness).

TABLE 1

| | | | | | | Test | |
|---|---|---|---|---|---|---|---|
| Composition at the time of polymerization | | | | | | Example 1 | Test Example 2 |
| | | Sodium | N,N′- | | Sodium | Ability of | pH- |
| | Acrylamide | acrylate | methylenebisacrylamide | Distilled | chloride | gel to keep | responsiveness |
| | (g) | (g) | (g) | water (g) | (g) | shape | for swelling |
| Example 1 | 2.5 | 0.5 | 0.006 | 20 | 5.4 | Keeps | Yes |
| | | | | | | stringy | |
| | | | | | | shape | |
| Example 2 | 2 | 1 | 0.006 | 20 | 5.4 | Keeps | Yes |
| | | | | | | stringy | |
| | | | | | | shape | |
| Example 3 | 1.5 | 1.5 | 0.006 | 20 | 5.4 | Keeps | Yes |
| | | | | | | stringy | |
| | | | | | | shape | |
| Comparative | 3 | 0 | 0.006 | 20 | 5.4 | Keeps | No |
| Example 1 | | | | | | stringy | |
| | | | | | | shape | |
| Comparative | 1 | 2 | 0.006 | 20 | 5.4 | Breaks | Yes |
| Example 2 | | | | | | after | |
| | | | | | | swelling | |
| Comparative | 0.5 | 2.5 | 0.006 | 20 | 5.4 | Breaks | Yes |
| Example 3 | | | | | | after | |
| | | | | | | swelling | |
| Comparative | 0 | 3 | 0.006 | 20 | 5.4 | Breaks | Yes |
| Example 4 | | | | | | after | |
| | | | | | | swelling | |

### Test Example 3

### Test on Polymeric Microparticles for Blood Adaptability

In two glass test tubes (15 mL) was placed each of 1-mL human blood incorporated with citric acid as an anticoagulant. In one of the test tubes was placed 10 g of the polymeric microparticles prepared in Example 4. After 10 minutes, the blood in both test tubes was examined for the number of blood cells by using Sysmex XE-2100 (made by Sysmex Co., Ltd.). It was found that the number of blood cells did not decrease after addition of the polymeric microparticles. Accordingly, the polymeric microparticles did not adsorb blood cells.

### Test Example 4

### Test on Polymeric Microparticles for Drug Adsorption

### 4)-1. Gemcitabine Hydrochloride

In a glass test tube (15 mL) was placed 10 mg of the polymeric microparticles prepared in Example 4. The test tube was given 10 mL of aqueous solution (dissolved in distilled water) of gemcitabine hydrochloride (“Gemzar” parenteral solution (200 mg), from Eli Lilly Japan K.K.) prepared at a concentration of 3.5 mg/mL. After centrifugation for three hours, the upper layer was recovered to determine the concentration of gemcitabine hydrochloride. It was found that the concentration of gemcitabine hydrochloride in the upper layer is 0.7 mg/mL. This suggests that the polymeric microparticles adsorb gemcitabine hydrochloride at a rate of 2.8 mg/mg.

### 4)-2. Doxorubicin Hydrochloride

In a glass test tube (15 mL) was placed 10 mg of the polymeric microparticles prepared in Example 4. The test tube was given 3 mL of 10-mL aqueous solution (dissolved in distilled water) of doxorubicin hydrochloride (product of RPG LIFE SCIENCE LIMITED) prepared at a concentration of 1 mg/mL. After centrifugation for 12 hours (overnight), the upper layer was recovered to determine the concentration of doxorubicin hydrochloride. It was found that the concentration of doxorubicin hydrochloride in the upper layer is 575 μg/mL. This suggests that the polymeric microparticles adsorb doxorubicin hydrochloride at a rate of 128 μg/mg.

The detailed description above describes features and aspects of an embodiment of a drug-adsorbing material and medical device disclosed by way of example. The disclosure is not limited, however, to the precise embodiment and variations described. Various changes, modifications and equivalents could be effected by one skilled in the art without departing from the spirit and scope of the disclosure as defined in the appended claims. It is expressly intended that all such changes, modifications and equivalents which fall within the scope of the claims are embraced by the claims.

### EXPLANATION OF REFERENCE SYMBOLS

1 Drug administrating device
2 Drug-adsorbing material
3 Circulating circuit
4, 5, 6 Tubes
7 Artificial lung
8 Three-way stop cock
8a First port
8b Second port
8c Third port
8d Lever
9 Branching connector
10 Hub
10a Feeding port for working fluid
10b Feeding port for drug
11 Tube
12 Drug eliminating means
12a Blood inlet
12b Blood outlet
13 Tube
14 Column
14a Column body
14b, 14c Lids
15, 16 Supporting members
17 First catheter
18 Artery
19 Expandable body
20 Tumor-bearing organ
21 Expandable body
22 Vein
23 Second catheter
24 Hub
24a Inlet for working fluid
25 Tube
26 Pump
27 Tube
28 Heat exchanger
29 Tube

What is claimed is:

1. A drug-adsorbing material, comprising:
polymeric microparticles capable of swelling upon adsorption of plasma components at a pH value of 7 or above, wherein the polymeric microparticles keep their shape after swelling.

2. The drug-adsorbing material according to claim 1, wherein the polymeric microparticles comprise a pH-responsive swelling crosslinked polymer (A) formed from a copolymer and a crosslinking agent (a3), said copolymer being composed of structural units derived from (meth)acrylamide monomer (a1) and structural units derived from unsaturated carboxylic acid monomer (a2).

3. The drug-adsorbing material according to claim 2, wherein the copolymer contains the structural units derived from (meth)acrylamide monomer (a1) in an amount of 40 to 90 mass % and the structural units derived from unsaturated carboxylic acid monomer (a2) in an amount of 60 to 10 mass %, and also contains the crosslinking agent (a3) in an amount of 0.1 to 1 mass % for 100 mass % of the monomers in the total amount.

4. A medical device, comprising the drug-adsorbing material according to claim 1.

5. The drug-adsorbing material according to claim 2, wherein the (meth)acrylamide monomer (a1) comprises (meth)acrylamide, N-methyl(meth)acrylamide, N-ethyl(meth)acrylamide, N-n-propyl(meth)acrylamide, N-isopropyl(meth)acrylamide, N-n-butyl(meth)acrylamide, N-isobutyl(meth)acrylamide, N-s-butyl(meth)acrylamide, N-t-butyl(meth)acrylamide, N,N-dimethyl(meth)acrylamide, N-ethyl-N-methyl(meth)acrylamide, N,N-diethyl(meth)acrylamide, N-methyl-N-n-propyl(meth)acrylamide, N-methyl-N-isopropyl(meth)acrylamide, N-ethyl-N-n-(meth)acrylamide, N-ethyl-N-isopropyl(meth)acrylamidepropyl, N,N-di-n-propyl(meth)acrylamide, diacetone(meth)acrylamide, crotonylamide, cinnamylamide, or a combination thereof.

6. The drug-adsorbing material according to claim 2, wherein the (meth)acrylamide monomer (a1) comprises (meth)acrylamide.

7. The drug-adsorbing material according to claim 2, wherein the unsaturated carboxylic acid monomer (a2) comprises (meth)acrylic acid, maleic acid, fumaric acid, glutaconic acid, itaconic acid, crotonic acid, sorbic acid, cinnamic acid, a salt of (meth)acrylic acid, a salt of maleic acid, a salt of fumaric acid, a salt of glutaconic acid, a salt of itaconic acid, a salt of crotonic acid, a salt of sorbic acid, a salt of cinnamic acid, or a combination thereof.

8. The drug-adsorbing material according to claim 2, wherein the unsaturated carboxylic acid monomer (a2) comprises (meth)acrylic acid, sodium(meth)acrylate, or a combination thereof.

9. The drug-adsorbing material according to claim 2, wherein the crosslinking agent (a3) comprises at least two polymerizable unsaturated groups.

10. The drug-adsorbing material according to claim 2, wherein the crosslinking agent (a3) comprises N,N′-methylenebisacrylamide.

11. The drug-adsorbing material according to claim 2, wherein the (meth)acrylamide monomer (a1) comprises (meth)acrylamide, wherein the unsaturated carboxylic acid monomer (a2) comprises (meth)acrylic acid, sodium(meth)acrylate, or a combination thereof, and wherein the crosslinking agent (a3) comprises N,N′-methylenebisacrylamide.

12. The drug-adsorbing material according to claim 1, wherein the polymeric microparticles in their dry state have an average particle diameter of 10 to 150 μm.

13. The drug-adsorbing material according to claim 1, wherein the polymeric microparticles are capable of swelling upon adsorption of plasma components at a pH value of 7.3 to 7.6.

14. The drug-adsorbing material according to claim 1, wherein the polymeric microparticles do not destroy erythrocytes, stimulate leukocytes to release mediators, or cause blood coagulation by enhancement of coagulation system.

15. The drug-adsorbing material according to claim 1, wherein the polymeric microparticles are free of surface coating.

16. A method of adsorbing a drug, the method comprising contacting the drug-adsorbing material according to claim 1 with blood.

17. The method according to claim 16, wherein the blood contains a carcinostatic agent, and wherein the carcinostatic agent is adsorbed onto the drug-adsorbing material.

18. The medical device according to claim 4, further comprising a blood inlet and a blood outlet.

19. A method of adsorbing a drug, the method comprising introducing blood to the blood inlet of the medical device according to claim 18.

20. The method according to claim 19, wherein the blood contains a carcinostatic agent, and wherein the carcinostatic agent is adsorbed onto the drug-adsorbing material.
